(19) United States
(12) Patent Application Publication
(10) Pub. No.: US 2026/0197041 A1
(43) Pub. Date: Jul. 9, 2026

(54) ELECTRONIC DEVICE AND OPERATING METHOD OF THE SAME

(71) Applicant: SAMSUNG ELECTRONICS CO., LTD., Suwon-si (KR)

(72) Inventors: Hyungyong LEE, Suwon-si (KR); Juhyun CHEON, Suwon-si (KR); Chanho JUNG, Suwon-si (KR); Kabkyun JEONG, Suwon-si (KR); Jehwan SEO, Suwon-si (KR); Chanyeob PARK, Suwon-si (KR); Junhan PARK, Suwon-si (KR); Yongjin KANG, Suwon-si (KR)

(73) Assignee: SAMSUNG ELECTRONICS CO., LTD., Suwon-si (KR)

(21) Appl. No.: 19/459,758

(22) Filed: Jan. 26, 2026

Related U.S. Application Data
(63) Continuation of application No. PCT/KR2025/022632, filed on Dec. 23, 2025.

(30) Foreign Application Priority Data
Jan. 9, 2025 (KR) 10-2025-0003736
Mar. 5, 2025 (KR) 10-2025-0028372

(51) Int. Cl. H04B 7/0413; H04B 15/02

(52) U.S. Cl. CPC H04B 7/0413; H04B 15/02

(57) ABSTRACT

An electronic device is provided. The electronic device includes a wireless communicator configured to communicate data with an external device; memory storing one or more instructions; and at least one processor including processing circuitry. The one or more instructions, when executed by the at least one processor individually or collectively, cause the electronic device to control the wireless communicator to operate in a multi-link operation (MLO) mode that is configured to simultaneously use a first frequency band and a second frequency band adjacent to the first frequency band for data transmission and to control the wireless communicator to operate in a multi-input multi-output (MIMO) mode that is configured to use the first frequency band or the second frequency band for data transmission based on an occurrence of interference in the first frequency band or the second frequency band.

### CROSS-REFERENCE TO RELATED APPLICATION(S)

This application is a bypass continuation application of International Patent Application No. PCT/KR2025/022632, filed on Dec. 23, 2025, which claims priority to and is based on Korean Patent Application No. 10-2025-0003736, filed on Jan. 9, 2025, and Korean Patent Application No. 10-2025-0028372, filed on Mar. 5, 2025, the disclosures of which are incorporated herein in their entireties by reference.

### BACKGROUND

### 1. Field

One or more embodiments of the disclosure relate to an electronic device and an operating method of the same for transmitting and receiving data to and from an external device by using a wireless fidelity (Wi-Fi) technology.

### 2. Description of Related Art

Devices may receive or transmit data by utilizing different frequency bands simultaneously in wireless communication systems. However, this approach may create interference between adjacent bands that degrades overall system performance. When operating upper 5 GHz channels and lower 6 GHz channels concurrently, interference may occur that compromises signal quality and reduces communication effectiveness. There exists a need for improved solutions that can address these interference challenges while enabling efficient utilization of available frequency spectrum across multiple bands.

### SUMMARY

According to an aspect of one or more embodiments of the present disclosure, an electronic device may include a wireless communicator configured to communicate data with an external device; memory storing one or more instructions; and at least one processor including processing circuitry. The one or more instructions, when executed by the at least one processor individually or collectively, may cause the electronic device to control the wireless communicator to operate in a multi-link operation (MLO) mode that is configured to simultaneously use a first frequency band and a second frequency band adjacent to the first frequency band for data transmission, and to control the wireless communicator to operate in a multi-input multi-output (MIMO) mode that is configured to use the first frequency band or the second frequency band for data transmission based on an occurrence of interference in the first frequency band or the second frequency band.

The wireless communicator may include a Wi-Fi module. The first frequency band may include a 5 GHz band. The second frequency band may include a 6 GHz band.

The one or more instructions, when executed by the at least one processor individually or collectively, may further cause the electronic device to monitor whether interference occurs in the first frequency band or the second frequency band based on quality of a network over which a signal of the first frequency band or a signal of the second frequency band is transmitted.

The quality of the network may be determined based on at least one of a number of transmission failures of a data packet transmitted over the network, a transmission failure rate of the data packet, a number of retransmissions of the data packet, latency time of the data packet, or a time ratio of a corresponding frequency band being used for data transmission.

The wireless communicator may include a first filter configured to pass a signal of the second frequency band; a second filter configured to pass a signal of the first frequency band; a first switch configured to switch the signal of the first frequency band or the signal of the second frequency band from a first port to the first filter or a first diplexer; and a second switch configured to switch the signal of the first frequency band or the signal of the second frequency band from a second port to the second filter or a second diplexer. The signal output from the first filter or the first diplexer may be transmitted to the external device through a first antenna. The signal output from the second filter or the second diplexer may be transmitted to the external device through a second antenna.

The one or more instructions, when executed by the at least one processor individually or collectively, may further cause the electronic device to control the wireless communicator to operate in the MLO mode based on control of the first switch so that a signal output from the first port is input to the first filter, and the second switch so that a signal output from the second port is input to the second filter.

The one or more instructions, when executed by the at least one processor individually or collectively, may cause the electronic device to, based on an occurrence of interference in the first frequency band, control the wireless communicator to operate in the MIMO mode configured to use the second frequency band for data communication based on control of the first switch so that a signal output from the first port is input to the first filter, and the second switch so that a signal output from the second port is input to the second diplexer.

The one or more instructions, when executed by the at least one processor individually or collectively, may cause the electronic device to, based on an occurrence of interference in the second frequency band, control the wireless communicator to operate in the MIMO mode which uses the first frequency band for data transmission based on control of the first switch so that a signal output from the first port is input to the first diplexer, and the second switch so that a signal output from the second port is input to the second filter.

The one or more instructions, when executed by the at least one processor individually or collectively, may cause the electronic device to determine whether to operate the wireless communicator in the MLO mode or the MIMO mode based on latency characteristics of transmission data.

The one or more instructions, when executed by the at least one processor individually or collectively, may further cause the electronic device to control the wireless communicator to operate in the MIMO mode configured to use a third frequency band for data transmission.

According to another aspect of one or more embodiments of the present disclosure, a method of operating an electronic device may include operating in a multi-link operation (MLO) mode to simultaneously use a first frequency band and a second frequency band adjacent to the first frequency band for data transmission; monitoring whether interference occurs in the first frequency band or the second frequency band; operating in a multi-input multi-output (MIMO) mode to use the second frequency band for data transmission based on an occurrence of interference in the first frequency band; and operating in a MIMO mode to use the first frequency band for data transmission based on an occurrence of interference in the second frequency band.

The first frequency band may include a 5 GHz band. The second frequency band may include a 6 GHz band.

The monitoring of whether interference occurs in the first frequency band or the second frequency band may be based on quality of a network over which a signal of the first frequency band or a signal of the second frequency band is transmitted.

The monitoring of whether interference occurs in the first frequency band or the second frequency band may include determining the quality of the network based on at least one of a number of transmission failures of a data packet transmitted over the network, a transmission failure rate of the data packet, a number of retransmissions of the data packet, latency time of the data packet, or a time ratio of a corresponding frequency band being used for data transmission.

A wireless communicator of the electronic device may include a first filter configured to pass a signal of the second frequency band; a second filter configured to pass a signal of the first frequency band; a first switch configured to switch the signal of the first frequency band or the signal of the second frequency band from a first port to the first filter or a first diplexer; and a second switch configured to switch the signal of the first frequency band or the signal of the second frequency band from a second port to the second filter or a second diplexer. The operating in the MLO mode to simultaneously use the first frequency band and the second frequency band adjacent to the first frequency band for data transmission may include: controlling the first switch so that a signal output through the first port is input to the first filter; and controlling the second switch so that a signal output through the second port is input to the second filter.

The operating in the MIMO mode to use the second frequency band for data transmission based on the occurrence of interference in the first frequency band may include controlling the first switch so that a signal output from the first port is input to the first filter; and controlling the second switch so that a signal output from the second port is input to the second diplexer.

The operating in the MIMO mode to use the first frequency band for data transmission based on the occurrence of interference in the second frequency band may include controlling the first switch so that a signal output from the first port is input to the first diplexer; and controlling the second switch so that a signal output from the second port is input to the second filter.

The method may further include determining whether to operate a wireless communicator of the electronic device in the MLO mode or the MIMO mode based on latency characteristics of transmission data.

The method may further include operating in a MIMO mode to uses a third frequency band for data transmission.

According to an aspect of one or more embodiments of the present disclosure, a non-transitory computer-readable medium having stored therein a program for performing the method.

### BRIEF DESCRIPTION OF DRAWINGS

Various embodiments in accordance with the present disclosure will be described with reference to the drawings, in which:

FIG. 1 illustrates an example electronic device and a display device, according to an embodiment of the present disclosure;

FIG. 2 is an example flowchart illustrating an operating method of an electronic device, according to an embodiment of the present disclosure;

FIG. 3 illustrates example components included in a wireless communicator of an electronic device, according to an embodiment of the present disclosure;

FIG. 4 is an example diagram for describing a method by which an electronic device operates in a multi-link operation (MLO) mode, according to an embodiment of the present disclosure;

FIG. 5 is an example diagram for describing a method by which an electronic device operates in a multi-input multi-output (MIMO) mode of a second frequency band, according to an embodiment of the present disclosure;

FIG. 6 is an example diagram for describing a method by which an electronic device operates in a MIMO mode of a first frequency band, according to an embodiment of the present disclosure;

FIG. 7 is an example diagram for describing a method by which an electronic device operates in a MIMO mode of a third frequency band, according to an embodiment of the present disclosure;

FIG. 8 is an example flowchart illustrating an operating method of an electronic device, according to an embodiment;

FIG. 9 is an example block diagram illustrating a configuration of an electronic device according to an embodiment of the present disclosure; and

FIG. 10 is an example block diagram illustrating a configuration of a display device, according to an embodiment of the present disclosure.

### DETAILED DESCRIPTION

Terms as used herein will be described before describing embodiments of the present disclosure in detail.

The terms are selected as common terms currently widely used, taking into account functions in the present disclosure, which may however depend on intentions of ordinary people in the art, judicial precedents, emergence of new technologies, and the like. Some terms as herein used are selected at the applicant's discretion, in which case, the meaning will be explained later in detail in the description of the present disclosure. Therefore, the terms should be defined based on their meanings and descriptions throughout the present disclosure.

Terms such as “comprising,” “having,” “including,” and “containing” are to be construed as open-ended terms (meaning “including, but not limited to,”) unless otherwise noted. The terms may specify the presence of stated features, numbers, steps, operations, elements, components or combinations thereof. The terms may not preclude the possibility of the presence or addition of one or more other features, numbers, steps, operations, elements, components, and/or combinations thereof. Recitation of ranges of values herein are merely intended to serve as a shorthand method of referring individually to each separate value falling within range, unless otherwise indicated herein and each separate value is incorporated into specification as if it were individually recited herein.

Embodiments of the present disclosure will now be described in detail with reference to accompanying drawings to be readily practiced by those of ordinary skill in the art. However, the embodiments of the present disclosure may be implemented in many different forms, and are not limited to those discussed herein. In the drawings, parts unrelated to the description are omitted for clarity, and like numerals refer to like elements throughout the specification.

In embodiments of the present disclosure, the term ‘user’ may refer to a person who controls a system, a function or an operation, including a developer, an administrator, or an installation engineer.

Furthermore, in embodiments of the present disclosure, the term ‘image’ or ‘picture’ may refer to a still image, a moving image comprised of a plurality of successive still images (or frames) or a video.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Further, the expressions such as “first,” “second,” and the like used in this specification may be used to describe various elements regardless of any order and/or degree of importance. Also, such expressions are used only to distinguish one element from another element, and are not intended to limit the elements.

Unless explicitly described or implicitly understood from one or more embodiments of the present disclosure, at least one of the components, elements, modules or units, or any nominalized verbs (collectively “components” in this paragraph) represented by a block or an equivalent indication in the drawings may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto. In other examples, the at least one processor may be implemented in application specific integrated circuit (ASIC) and field-programmable gate array (FPGA).

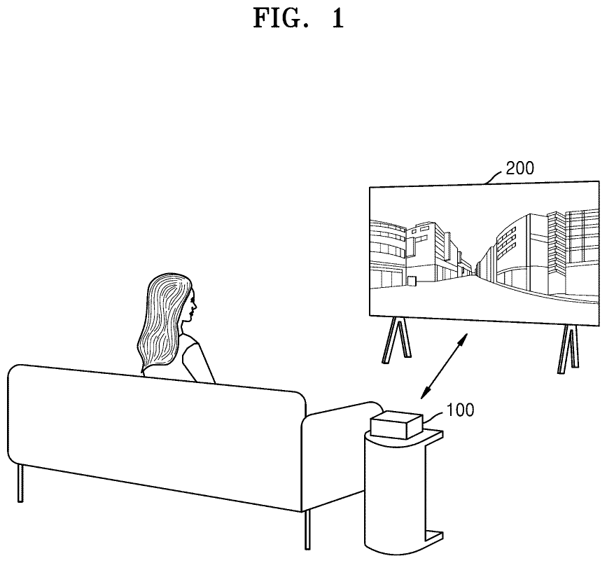

FIG. 1 illustrates an example electronic device and a display device, according to an embodiment of the present disclosure.

Referring to FIG. 1, an electronic device 100 and a display device 200 according to an embodiment may be connected by wireless communication.

In an embodiment of the present disclosure, the electronic device 100 may transmit image data or audio data to the display device 200. The display device 200 may output the image data and the audio data received from the electronic device 100.

In an embodiment of the present disclosure, the electronic device 100 may include a set-top box, a DVD player, a Blu-ray disc, a PC, a game device, a streaming device, a home theater, etc. The electronic device 100 may include various types of electronic devices capable of providing content to the display device 200.

In an embodiment of the present disclosure, the electronic device 100 may receive various contents from an external device, and transmit the received content to the display device 200. For example, the electronic device 100 may receive over-the-top (OTT) content provided from an OTT service provider, and transmit the received OTT content to the display device 200. The electronic device 100 may also receive broadcast content from a broadcasting network and transmit the broadcast content to the display device 200. The electronic device 100 may also receive game content from a game device and transmit the game content to the display device 200. It is not, however, limited thereto.

The electronic device 100 is a device for providing content and may be referred to as a source device or as a host device, a content providing device, a storage device, a computing device, a server device, a server, or the like.

In an embodiment of the present disclosure, the display device 200 may output or display content received from the electronic device 100. The display device 200 may include various types of electronic devices such as, for example, a network TV, a smart TV, an Internet TV, a web TV, an IPTV, a PC, etc., capable of receiving and outputting content. The display device 200 is a device for receiving and displaying content, and may be referred to as a receiving device or receiver (RX), a sync device, an electronic device or a computing device.

In an embodiment of the present disclosure, the electronic device 100 and the display device 200 may be connected to each other over a wireless communication network. Wireless communication may be performed between the electronic device 100 and the display device 200 through a wireless communication interface included in the electronic device 100 and a wireless communication interface included in the display device 200.

In an embodiment of the present disclosure, the electronic device 100 and the display device 200 may perform data communication through a wireless communication scheme such as wireless LAN, Wi-Fi, Bluetooth, Bluetooth low energy (BLE), Zigbee, Wi-Fi direct (WFD), near field communication (NFC), world interoperability for microwave access (WiMAX), shared wireless access protocol (SWAP), wireless gigabit alliance (WiGig) or RF communication.

In an embodiment of the present disclosure, the electronic device 100 and the display device 200 may use the Wi-Fi communication scheme to perform data communication. For example, the electronic device 100 and the display device 200 may use a Wi-Fi 7 technology to perform data communication. Furthermore, the electronic device 100 and the display device 200 may include a Wi-Fi module capable of performing Wi-Fi communication.

In an embodiment of the present disclosure, in performing data communication by using the Wi-Fi communication scheme, the electronic device 100 and the display device 200 may use a certain frequency band (e.g., 2.4 Giga Hertz (GHz) band, 5 GHz band or 6 GHz band) to transmit or receive data.

For example, the electronic device 100 and the display device 200 may perform data communication by simultaneously (e.g., at the same time) using a first frequency band and a second frequency band adjacent (e.g., The upper frequency limit of one band is at or very close to the lower frequency limit of the next band) to the first frequency band. Such an operation of performing communication by simultaneously using different frequency bands may be referred to as a multi-link operation (MLO), without being limited thereto. By transmitting and receiving data in an MLO mode, the electronic device 100 and the display device 200 may increase the data transmission rate and reduce latency time.

Alternatively, the electronic device 100 and the display device 200 may operate in a multi-input multi-output (MIMO) mode that transmits and receives data having the same frequency band through multiple paths. Data transmission and reception in the MIMO mode between the electronic device 100 and the display device 200 may speed up data transmission and use frequency resources efficiently because multiple data may be transmitted simultaneously in one frequency band.

In an embodiment of the present disclosure, for data transmission, the electronic device 100 may transmit data to the display device 200 in the MLO mode or the MIMO mode based on a network environment. Alternatively, in an embodiment of the present disclosure, for data transmission, the electronic device 100 may transmit data to the display device 200 in the MLO mode or the MIMO mode based on characteristics of data for transmission (e.g., transmission data).

In an embodiment of the present disclosure, for data transmission, the display device 200 may also transmit data to the electronic device 100 in the MLO mode or the MIMO mode, based on a network environment. Alternatively, in an embodiment of the present disclosure, for data transmission, the display device 200 may transmit data to the electronic device 100 in the MLO mode or the MIMO mode, based on characteristics of transmission data.

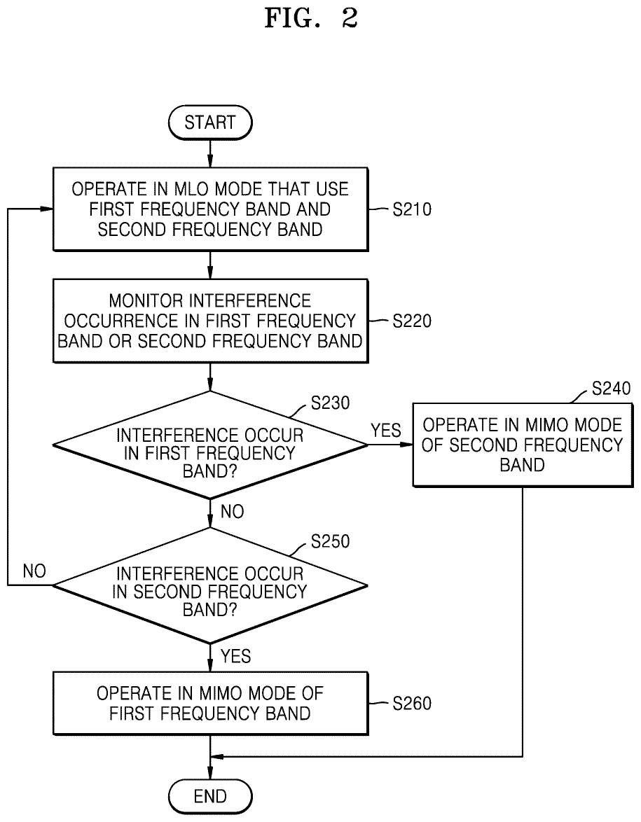

FIG. 2 is an example flowchart illustrating an operating method of an electronic device, according to an embodiment.

In an embodiment of the present disclosure, the electronic device 100 may communicate with the display device 220. For example, the electronic device 100 may transmit or receive data to or from the display device 200. An operation of the electronic device 100 for transmitting data to the display device 200 will now be described as a basis.

Referring to FIG. 2, the electronic device 100 may transmit data to the display device 200 in the MLO mode that uses the first frequency band and the second frequency band, in S210.

In an embodiment of the present disclosure, the MLO mode may refer to a technology that simultaneously uses multiple frequency bands for data transmission. For example, the electronic device 100 may increase the data transmission rate and minimize the latency time by transmitting data through a first frequency band link and a second frequency band link. The electronic device 100 may transmit data on one link (the first frequency band link) and receive data on the other link (the second frequency link), thereby processing the transmission and reception operations at the same time. Even when the one link experiences performance degradation due to interference or congestion, the electronic device 100 may maintain connection stability through the other link. Furthermore, the electronic device 100 may transmit or receive a first type of data on one link and transmit or receive a second type of data on the other link, thereby minimizing the latency time and increasing data transmission/reception efficiency. It is not, however, limited thereto.

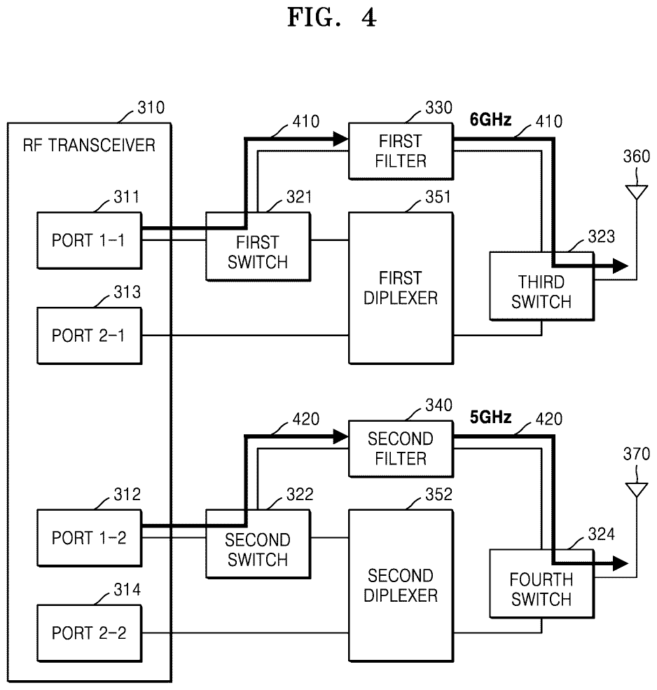

The electronic device 100 may operate in the MLO mode by transmitting data (signal) having a frequency band of 5 GHz on a first link and transmitting data (signal) having a frequency band of 6 GHz on a second link. In this case, the first link may include a first filter that passes only a frequency band of 5 GHz and the second link may include a second filter that passes only a frequency band of 6 GHz. A configuration in which the electronic device 100 operates in the MLO mode will be described in detail with reference to FIG. 4.

In an embodiment of the present disclosure, the electronic device 100 may monitor whether interference occurs in the first frequency band or the second frequency band, in S220.

The occurrence of interference in the first frequency band may refer to degradation of quality of data transmission that uses the first frequency band because many signals using the first frequency band collide with each other. Furthermore, the occurrence of interference in the second frequency band may refer to degradation of quality of data transmission that uses the second frequency band because many signals using the second frequency band collide with each other.

In an embodiment of the present disclosure, the electronic device 100 may determine a quality of a network over which a signal of the first frequency band or a signal of the second frequency band is transmitted. For example, the electronic device 100 may estimate quality of transmission signals of the first frequency band or quality of transmission signals of the second frequency band. The electronic device 100 may estimate the quality of transmission signals based on the number of packets that have failed to be transmitted among a plurality of packets transmitted using the corresponding frequency band, a packet transmission failure rate, the number of packet retransmissions, packet latency time, a time ratio (busy time) of the corresponding frequency band being used for data transmission, etc.

For example, the electronic device 100 may identify that the higher the number of packets that have failed to be transmitted, the lower the quality of transmission signals and that interference occurs in the signal of the corresponding frequency band.

The electronic device 100 may identify that the higher the packet transmission failure rate or the higher the number of packet retransmissions, the lower the quality of transmission signals and that interference occurs in the signal of the corresponding frequency band.

The electronic device 100 may identify that the longer the packet latency time, the lower the quality of transmission signals and that interference occurs in the signal of the corresponding frequency band.

The electronic device 100 may identify that the higher the time ratio of the corresponding frequency band being used for data transmission, the lower the quality of transmission signals and that interference occurs in the signal of the corresponding frequency band. It is not, however, limited thereto.

In an embodiment of the present disclosure, when interference occurs in a signal having the first frequency band in S230, the electronic device 100 may transmit data to the display device 200 in the MIMO mode that transmits data through a plurality of links of the second frequency band in S240.

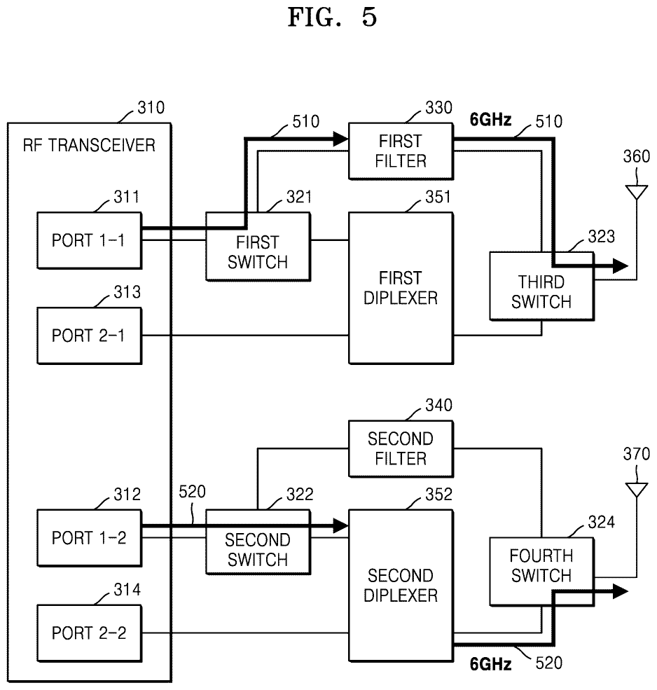

For example, when interference occurs in a signal having a frequency band of 5 GHz, the electronic device 100 may transmit data having a frequency band of 6 GHz on a plurality of links. A configuration in which the electronic device 100 operates in the MIMO mode of a frequency band of 6 GHz will be described in detail with reference to FIG. 5.

In an embodiment of the present disclosure, when interference occurs in a signal having the second frequency band in S250, the electronic device 100 may transmit data to the display device 200 in the MIMO mode that transmits data through a plurality of links of the first frequency band in S260.

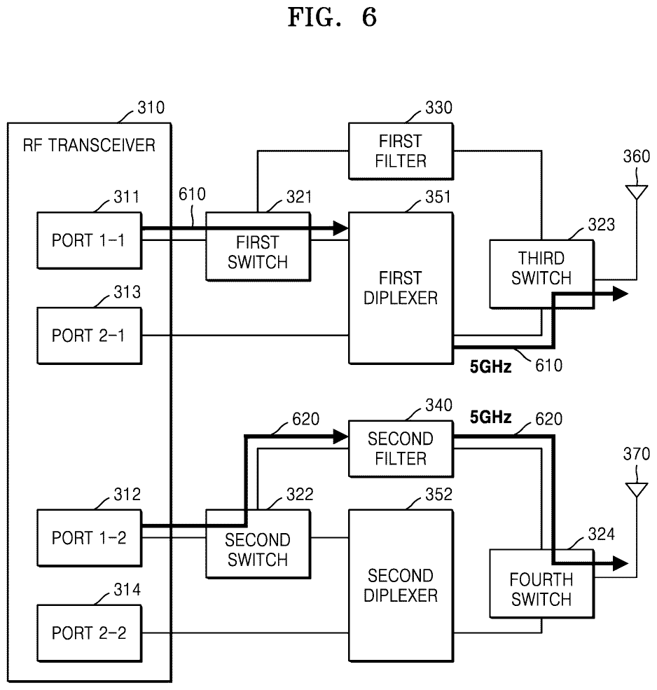

For example, when interference occurs in a signal having a frequency band of 6 GHz, the electronic device 100 may transmit data having a frequency band of 5 GHz on a plurality of links. A configuration in which the electronic device 100 operates in the MIMO mode of a frequency band of 5 GHz will be described in detail with reference to FIG. 6.

In an embodiment of the present disclosure, when no interference occurs in a signal having the first frequency band and a signal having the second frequency band, the electronic device 100 may operate in the MLO mode by transmitting a signal having a frequency band of 5 GHz on the first link and transmitting a signal having a frequency band of 6 GHz on the second link.

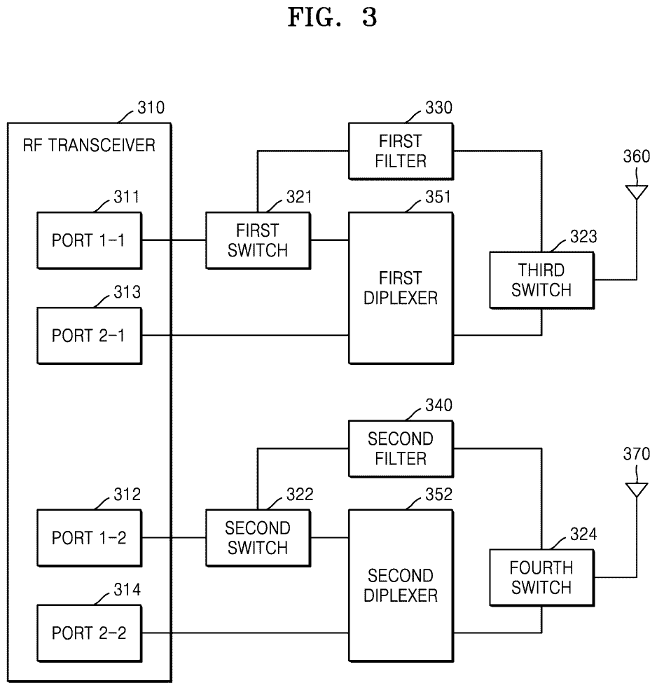

FIG. 3 illustrates example components included in a wireless communicator of an electronic device, according to an embodiment.

Referring to FIG. 3, the wireless communicator of the electronic device 100 according to an embodiment may include an RF transceiver 310, a first switch 321, a second switch 322, a first filter 330, a second filter 340, a first diplexer 351, a second diplexer 352, a third switch 323, a fourth switch 324, a first antenna 360 and a second antenna 370.

In an embodiment of the present disclosure, the RF transceiver 310 may convert a digital signal corresponding to data to an analog RF signal. For example, the RF transceiver 310 may use a digital-to-analog converter (DAC) to convert a digital signal received from a baseband processor to an analog signal. The RF transceiver 310 may also modulate the signal converted to the analog signal into a certain frequency band. For example, the transceiver 310 may convert an in-phase/quadrature (I/Q) signal having a baseband signal form generated by the baseband processor to an analog RF signal having an analog RF frequency. It is not, however, limited thereto.

In an embodiment of the present disclosure, the RF transceiver 310 may generate signals having a first frequency band, a second frequency band and a third frequency band. The first frequency band may be a 5 GHz band, and the second frequency band may be a 6 GHz band. The first frequency band may range from 5.180 to 5.850 GHz, and the second frequency band may range from 5.925 GHz to 7.125 GHz. Alternatively, the first frequency band may be the 6 GHz band, and the second frequency band may be the 5 GHz band. The third frequency band may be a 2.4 GHz band.

In the following description, it is assumed, without limitation, that the first frequency band is the 5 GHz band, the second frequency band is the 6 GHz band, and the third frequency band is the 2.4 GHz band.

In an embodiment of the present disclosure, the RF transceiver 310 may include port 1-1 311, port 2-1 313, port 1-2 312 and port 2-2 314 for outputting RF signals. In various examples, there may be additional ports within the RF transceiver 310.

The port 1-1 311 and the port 1-2 312 may output signals (data) having the 5 GHz frequency band or signals (data) having the 6 GHz frequency band. The port 2-1 313 and the port 2-2 314 may output signals (data) having the 2.4 GHz frequency band. It is not, however, limited thereto.

In an embodiment of the present disclosure, the first switch 321 may switch the signal output from the port 1-1 311 to the first filter 330 or the first diplexer 351. The first switch 321 may include an RF switch. The RF switch may switch or route a radio frequency signal along various paths.

The first filter 330 may include a bandpass filter that passes signals of only the second frequency band. For example, the first filter 330 may pass signals only having the 6 GHz band. It is not, however, limited thereto.

A signal output from the first filter 330 may be transmitted to an external device through the first antenna 360.

The first diplexer 351 may transmit the signal output from the port 1-1 311 and the signal output from the port 2-1 313 to the first antenna 360.

The first diplexer 351 may separate or combine signals of different frequency bands. The first diplexer 351 may combine the signal output from the port 1-1 311 and the signal output from the port 2-1 313 and transmit the combined signal to the first antenna 360. It may also separate signals of different frequency bands received from the first antenna 360 and transmit the separated signals to the port 1-311 and the port 2-1 313.

For example, when a signal of the first frequency band or a signal of the second frequency band is switched from the first switch 321 and input to the first diplexer 351, the first diplexer 351 may transmit the input signal to the first antenna 360. The first diplexer 351 may transmit the signal of the 5 GHz band or the signal of the 6 GHz band output from the port 1-1 311 to the first antenna 360.

The first diplexer 351 may also transmit the signal output from the port 2-1 313 to the first antenna 360. For example, the signal of the 2.4 GHz band output from the port 2-1 313 may be input to the first diplexer 351, and the first diplexer 351 may forward the signal of the 2.4 GHz band to the first antenna 360.

In an embodiment of the present disclosure, the first antenna 360 may be a component for the electronic device 100 to transmit or receive electromagnetic waves in a certain range from an external electronic device or an external server. For example, the electronic device 100 may transmit data to the display device 200 through the first antenna 360. Furthermore, the electronic device 100 may obtain a control signal or a request signal from the display device 200 through the first antenna 360. It is not, however, limited thereto.

In an embodiment of the present disclosure, the first antenna 360 may include an omnidirectional antenna, a directional antenna, a beamforming antenna, etc. A size or shape of the first antenna 360 may be determined by taking into account a frequency band of a signal to be transmitted or received by the electronic device 100 through the first antenna 360, a position of the first antenna 360 in the electronic device 100, a positional relationship or deployment relationship between different components, etc. It is not, however, limited thereto.

The first antenna 360 may include a multi-band antenna capable of transmitting or receiving signals of a plurality of frequency bands. It is not, however, limited thereto.

In an embodiment of the present disclosure, the third switch 323 may switch the signal received through the first antenna 360 to the first filter 330 or the first diplexer 351. The first filter 330 may transmit the received signal to the port 1-1 311. The first diplexer 351 may transmit the signal received from the first antenna 360 to the port 1-1 311 or the port 2-1 313. For example, the first diplexer 351 may transmit a signal of the 5 GHz band or a signal of the 6 GHz band to the port 1-1 311, and transmit a signal of the 2.4 GHz band to the port 2-1 313.

In an embodiment of the present disclosure, the second switch 322 may switch a signal output from the port 1-2 312 to the second filter 340 or the second diplexer 352. The second switch 322 may include an RF switch. The RF switch may switch or route a radio frequency signal along various paths.

The second filter 340 may include a bandpass filter that passes signals of only the first frequency band. For example, the second filter 340 may pass signals only having the 5 GHz band. It is not, however, limited thereto.

A signal output from the second filter 340 may be transmitted to an external device through the second antenna 370.

The second diplexer 352 may transmit the signal output from the port 1-2 312 and the signal output from the port 2-2 314 to the second antenna 370.

The second diplexer 352 may separate or combine signals of different frequency bands. The second diplexer 352 may combine the signal output from the port 1-2 312 and the signal output from the port 2-2 314 and transmit the combined signal to the second antenna 370. It may also separate signals of different frequency bands received from the second antenna 370 and transmit the separated signals to the port 1-2 312 and the port 2-2 314.

For example, when a signal of the first frequency band or a signal of the second frequency band is switched from the second switch 322 and input to the second diplexer 352, the second diplexer 352 may transmit the input signal to the second antenna 370. The second diplexer 352 may transmit the signal of the 5 GHz band or the signal of the 6 GHz band output from the port 1-2 312 to the second antenna 370.

The second diplexer 352 may transmit the signal output from the port 2-2 314 to the second antenna 370. For example, the signal of the 2.4 GHz band output from the port 2-2 314 may be input to the second diplexer 352, and the second diplexer 352 may forward the signal of the 2.4 GHz band to the second antenna 370.

In an embodiment of the present disclosure, the second antenna 370 may be a component for the electronic device 100 to transmit or receive electromagnetic waves in a certain range from an external electronic device or an external server. For example, the electronic device 100 may transmit data to the display device 200 through the second antenna 370. Furthermore, the electronic device 100 may obtain a control signal or a request signal from the display device 200 through the second antenna 370. It is not, however, limited thereto.

In an embodiment of the present disclosure, the second antenna 370 may include an omnidirectional antenna, a directional antenna, a beamforming antenna, etc. A size or shape of the second antenna 370 may be determined by taking into account a frequency band of a signal to be transmitted or received by the electronic device 100 through the second antenna 370, a position of the second antenna 370 in the electronic device 100, a positional relationship or deployment relationship between different components, etc. It is not, however, limited thereto.

The second antenna 370 may include a multi-band antenna capable of transmitting or receiving signals of a plurality of frequency bands. It is not, however, limited thereto.

In an embodiment of the present disclosure, the fourth switch 324 may switch the signal received through the second antenna 370 to the second filter 340 or the second diplexer 352. The second filter 340 may transmit the received signal to the port 1-2 312. The second diplexer 352 may transmit the signal received from the second antenna 370 to the port 1-2 312 or the port 2-2 314. For example, the second diplexer 352 may transmit a signal of the 5 GHz band or a signal of the 6 GHz band to the port 1-2 312, and transmit a signal of the 2.4 GHz band to the port 2-2 314.

In an embodiment of the present disclosure, by including the aforementioned components, the wireless communicator of the electronic device 100 may operate in at least one of an MLO mode that uses both the first frequency band and the second frequency band for data transmission, a MIMO mode of the first frequency mode, a MIMO mode of the second frequency mode, or a MIMO mode of the third frequency band.

FIG. 4 is an example diagram for describing a method by which an electronic device operates in an MLO mode, according to an embodiment.

In an embodiment of the present disclosure, the electronic device 100 may determine a data transmission mode for data transmission. For example, the electronic device 100 may transmit data in an MLO mode that transmits data by using different frequency bands or transmit data in a MIMO mode using the same frequency band. The electronic device 100 may determine a data transmission mode based on a network environment or characteristics of transmission data.

When operating in the MLO mode, the electronic device 100 may transmit data by using different frequency bands. For example, the electronic device 100 may transmit a signal having the first frequency band and a signal having the second frequency band to an external device.

The RF transceiver 310 may output a signal having the second frequency band (6 GHz) through the port 1-1 311, and output a signal having the first frequency band (5 GHz) through the port 1-2 312.

The first switch 321 may switch the signal output from the port 1-1 311 to be input to the first filter 330. The first filter 330 may pass signals only having the second frequency band. For example, the first filter 330 may pass only signals ranging from 5.925 GHz to 7.125 GHz. Accordingly, signals of the 6 GHz band may pass the first filter 330 and may be transmitted to the first antenna 360. The signal of the 6 GHz band transmitted to the first antenna 360 may be transmitted to an external device through the first antenna 360.

The second switch 322 may switch the signal output through the port 1-2 312 to be input to the second filter 340. The second filter 340 may pass signals only having the first frequency band. For example, the second filter 340 may pass only signals ranging from 5.180 GHz to 5.850 GHz. Accordingly, signals of the 5 GHz band may pass the second filter 340 and may be transmitted to the second antenna 370. The signal of the 5 GHz band transmitted to the second antenna 370 may be transmitted to an external device through the second antenna 370.

In an embodiment of the present disclosure, the electronic device 100 may transmit the signal having the second frequency band to the external device through a first transmission path 410, and transmit the signal having the first frequency band to the external device through a second transmission path 420.

In an embodiment of the present disclosure, as the electronic device 100 operates the wireless communicator in the MLO mode, the data transmission rate may become higher. Furthermore, in an embodiment of the present disclosure, as the electronic device 100 operates the wireless communicator in the MLO mode, it may operate in a full duplex mode. For example, the electronic device 100 may use the first frequency band to transmit a signal to the external device, and use the second frequency band to receive a signal from the external device. As different frequency bands are used for data transmission and reception, the transmission and reception may be performed without interference in the signal.

FIG. 5 is an example diagram for describing a method by which an electronic device operates in a MIMO mode of a second frequency band, according to an embodiment.

In an embodiment of the present disclosure, the electronic device may determine a data transmission mode for data transmission. For example, the electronic device 100 may determine the data transmission mode based on a network environment.

In an embodiment of the present disclosure, the electronic device 100 may identify whether interference occurs in the transmission signal. For example, the electronic device 100 may monitor whether a network environment is good or interference occurs by estimating the quality of the transmission signal. The electronic device 100 may estimate quality of transmission signals of the first frequency band or quality of transmission signals of the second frequency band.

In an embodiment of the present disclosure, the quality of transmission signals may be estimated based on the number of packets that have failed to be transmitted among a plurality of packets transmitted using the corresponding frequency band, a packet transmission failure rate, the number of packet retransmissions, packet latency time, a time ratio (busy time) of the corresponding frequency band being used for data transmission, etc. For example, the electronic device 100 may identify that the higher the number of packets that have failed to be transmitted, the lower the quality of transmission signals and that interference occurs in the corresponding frequency band signal.

The electronic device 100 may identify that the higher the packet transmission failure rate or the higher the number of packet retransmissions, the lower the quality of transmission signals and that interference occurs in the corresponding frequency band signal.

The electronic device 100 may identify that the longer the packet latency time, the lower the quality of transmission signals and that interference occurs in the corresponding frequency band signal.

The electronic device 100 may identify that the higher the time ratio of the corresponding frequency band being used for data transmission, the lower the quality of transmission signals and that interference occurs in the corresponding frequency band signal. It is not, however, limited thereto.

In an embodiment of the present disclosure, when identifying that interference occurs in the signal of the first frequency band (5 GHz band), the electronic device 100 may use the second frequency band (6 GHz band) to transmit data. For example, the electronic device 100 may operate in the MIMO mode that transmits or receives data having the second frequency band through multiple paths.

Referring to FIG. 5, when operating in the MIMO mode of the second frequency band, the RF transceiver 310 may output signals having the second frequency band (6 GHz band) through the port 1-1 311 and the port 1-2 312.

The first switch 321 may switch the signal output through the port 1-1 311 to be input to the first filter 330. The first filter 330 may pass signals only having the second frequency band. For example, the first filter 330 may pass only signals ranging from 5.925 GHz to 7.125 GHz. Accordingly, signals of the 6 GHz band may pass the first filter 330 and may be transmitted to the first antenna 360. The signal of the 6 GHz band transmitted to the first antenna 360 may be transmitted to an external device through the first antenna 360.

In an embodiment of the present disclosure, the second switch 322 may switch the signal output from the port 1-2 312 to be input to the second diplexer 352. Accordingly, signals of the 6 GHz band may pass the second diplexer 352 and may be transmitted to the second antenna 370. The signal of the 6 GHz band transmitted to the second antenna 370 may be transmitted to an external device through the

### Second Antenna 370.

In an embodiment of the present disclosure, the electronic device 100 may transmit the signal having the second frequency band to the external device through a first transmission path 510, and transmit the signal having the second frequency band to the external device through a second transmission path 520.

In an embodiment of the present disclosure, as the electronic device 100 operates the wireless communicator in the MIMO mode, the data transmission rate may become higher.

FIG. 6 is an example diagram for describing a method by which an electronic device operates in a MIMO mode of a first frequency band, according to an embodiment.

In an embodiment of the present disclosure, the electronic device may determine a data transmission mode for data transmission. For example, the electronic device 100 may determine the data transmission mode based on a network environment.

In an embodiment of the present disclosure, the electronic device 100 may identify whether interference occurs in a transmission signal of the second frequency band (6 GHz band). For example, the electronic device 100 may monitor whether a network environment is good or interference occurs by estimating the quality of the transmission signal of the second frequency band.

In an embodiment of the present disclosure, the quality of transmission signals may be estimated based on the number of packets that have failed to be transmitted among a plurality of packets transmitted using the corresponding frequency band, a packet transmission failure rate, the number of packet retransmissions, packet latency time, a time ratio (busy time) of the corresponding frequency band being used for data transmission, etc. For example, the electronic device 100 may identify that the higher the number of packets that have failed to be transmitted, the lower the quality of transmission signals and that interference occurs in the signal of the corresponding frequency band.

In an embodiment of the present disclosure, when identifying that interference occurs in the signal of the second frequency band (6 GHz band), the electronic device 100 may use the first frequency band (5 GHz band) to transmit data. For example, the electronic device 100 may operate in the MIMO mode that transmits or receives data having the first frequency band through multiple paths.

Referring to FIG. 6, when operating in the MIMO mode of the first frequency band, the RF transceiver 310 may output signals having the first frequency band (5 GHz band) through the port 1-1 311 and the port 1-2 312.

The first switch 321 may switch the signal output through the port 1-1 311 to be input to the first diplexer 351. Accordingly, signals of the 5 GHz band may pass the first diplexer 351 and may be transmitted to the first antenna 360. The signal of the 5 GHz band transmitted to the first antenna 360 may be transmitted to an external device through the first antenna 360.

In an embodiment of the present disclosure, the second switch 322 may switch the signal output through the port 1-2 312 to be input to the second filter 340. The second filter 340 may pass signals only having the first frequency band. For example, the second filter 340 may pass only signals ranging from 5.180 GHz to 5.850 GHz.

Accordingly, signals of the 5 GHz band may pass the second filter 340 and may be transmitted to the second antenna 370. The signal of the 5 GHz band transmitted to the second antenna 370 may be transmitted to an external device through the second antenna 370.

In an embodiment of the present disclosure, the electronic device 100 may transmit the signal having the first frequency band to the external device through a first transmission path 610, and transmit the signal having the first frequency band to the external device through a second transmission path 620.

In an embodiment of the present disclosure, as the electronic device 100 operates the wireless communicator in the MIMO mode, the data transmission rate may become higher.

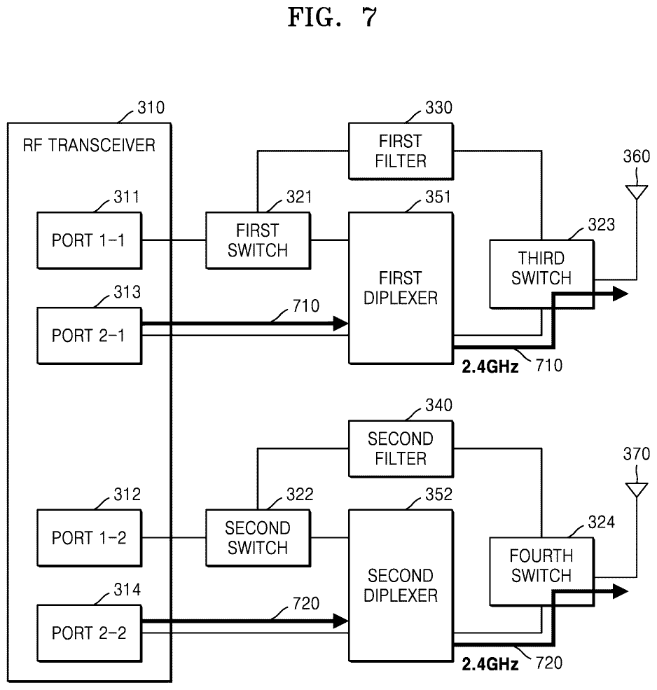

FIG. 7 is an example diagram for describing a method by which an electronic device operates in a MIMO mode of a third frequency band, according to an embodiment.

Referring to FIG. 7, the electronic device 100 according to an embodiment may operate in the MIMO mode that transmits or receives data having the third frequency band (2.4 GHz band) through multiple paths.

When operating in the MIMO mode of the third frequency band, the RF transceiver 310 may output signals having the third frequency band (2.4 GHz band) through the port 2-1 313 and the port 2-2 314.

The signal of the 2.4 GHz band output through the port 2-1 313 may be input to the first diplexer 351, may pass the first diplexer 351 and may be transmitted to the first antenna 360. The signal of the 2.4 GHz band transmitted to the first antenna 360 may be transmitted to an external device through the first antenna 360.

The 2.4 GHz signal output through the port 2-2 314 may be input to the second diplexer 352, may pass the second diplexer 352 and may be transmitted to the second antenna 370. The signal of the 2.4 GHz band transmitted to the second antenna 370 may be transmitted to an external device through the second antenna 370.

In an embodiment of the present disclosure, the electronic device 100 may transmit the signal having the third frequency band to the external device through a first transmission path 710, and transmit the signal having the third frequency band to the external device through a second transmission path 720.

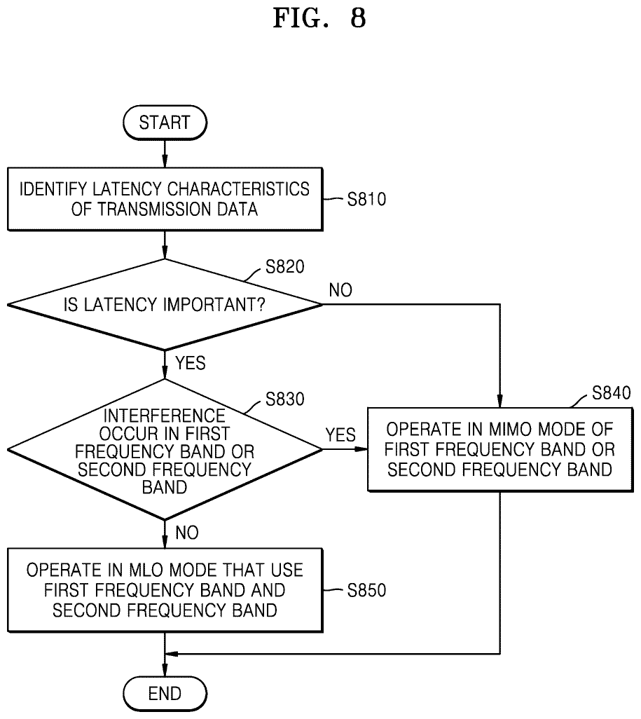

FIG. 8 is an example flowchart illustrating an operating method of an electronic device, according to an embodiment.

In an embodiment of the present disclosure, the electronic device 100 may transmit or receive data to or from the display device 200.

Referring to FIG. 8, the electronic device 100 may identify characteristics of data to be transmitted. For example, the electronic device 100 may identify, without limitation, a type of the transmission data, a bandwidth required for the transmission data, real-time properties, confidence, signal quality, etc.

The electronic device 100 may identify an importance degree of latency of the transmission data based on the characteristics of the transmission data, in S810. For example, when the transmission data requires to be transmitted in real-time or requires low latency, the electronic device 100 may identify that the importance degree of the latency of the transmission data is high. The electronic device 100 may identify, without limitation, real-time broadcast content such as a sport game, online game content, etc., as data whose latency is highly important..

In an embodiment of the present disclosure, when latency is not or less important (e.g., does not meet or exceed a threshold) for transmitting data, the electronic device 100 may transmit the data in the MIMO mode of the first frequency band or the MIMO mode of the second frequency band in S840.

For example, the electronic device 100 may transmit data having the first frequency band on multiple links or transmit data having the second frequency band on multiple links. When interference occurs in the signal having the first frequency band (e.g., 5 GHz band), the electronic device 100 may transmit data having the second frequency band (e.g., 6 GHz band) on multiple links. The method by which the electronic device 100 operates in the MIMO mode of the second frequency band (e.g., 6 GHz band) was described in detail with reference to FIG. 5.

When interference occurs in the signal having the second frequency band (e.g., 6 GHz band), the electronic device 100 may transmit data having the first frequency band (e.g., 5 GHz band) on multiple links. The method of operating in the MIMO mode of the first frequency band (e.g., 5 GHz band) was described in detail with reference to FIG. 6.

In an embodiment of the present disclosure, when the transmission data is identified as data whose latency is important in S820, the electronic device 100 may monitor whether there is interference occurring in the first frequency band or the second frequency band in S830.

The occurrence of interference in the first frequency band may refer to degradation of quality of data transmission that uses the first frequency band because many signals using the first frequency band collide with each other. Furthermore, the occurrence of interference in the second frequency band may refer to degradation of quality of data transmission that uses the second frequency band because many signals using the second frequency band collide with each other.

When no interference occurs in the first frequency band and the second frequency band, the electronic device 100 may transmit data in the MLO mode that uses the first frequency band and the second frequency band in S850.

For example, the electronic device 100 may increase the data transmission rate and minimize the latency time by transmitting data through a first frequency band link and a second frequency band link. The electronic device 100 may transmit data on one link (the first frequency band link) and receive data on the other link (the second frequency link), thereby processing the transmission and reception operations at the same time.

The method of transmitting data in the MLO mode that uses the first frequency band and the second frequency band was described in detail with reference to FIG. 4.

On the other hand, when interference occurs in the first frequency band or the second frequency band, the electronic device 100 may transmit data in the MIMO mode of a frequency band in which no interference occurs, in S840.

For example, when interference occurs in the signal having the first frequency band (e.g., 5 GHz band), the electronic device 100 may transmit data having the second frequency band (e.g., 6 GHz band) on multiple links. The method of operating in the MIMO mode of the second frequency band (e.g., 6 GHz band) was described in detail with reference to FIG. 5.

When interference occurs in the signal having the second frequency band (e.g., 6 GHz band), the electronic device 100 may transmit data having the first frequency band (e.g., 5 GHz band) on multiple links. The method of operating in the MIMO mode of the first frequency band (e.g., 5 GHz band) was described in detail with reference to FIG. 6.

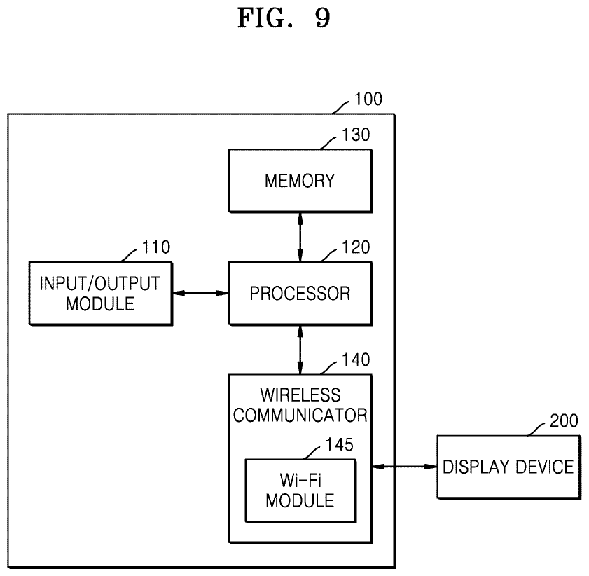

FIG. 9 is an example block diagram illustrating a configuration of an electronic device according to an embodiment.

Referring to FIG. 9, the electronic device 100 according to an embodiment may include an input/output module 110, a processor 120, memory 130 and a wireless communicator 140.

In an embodiment of the present disclosure, the input/output module 110 may receive a video (e.g., a moving image), an audio (e.g., a speech, music, etc.), additional information (e.g., an EPG), or the like from outside of the electronic device 100. The input/output module 110 may include any of a high-definition multimedia interface (HDMI), a mobile high-definition link (MHL), a universal serial bus (USB), a display port (DP), a thunderbolt, a video graphics array (VGA) port, an RGB port, a D-subminiature (D-SUB), a digital visual interface (DVI), a component jack, and a PC port. It is not, however, limited thereto, and the input/output module 110 may include various input/output interfaces capable of transmitting and receiving content to or from external devices. For example, the input/output module 110 may receive various contents from external devices. In an embodiment of the present disclosure, the contents may include multimedia contents, including images, video, audio, text, games, applications, broadcast, etc., without being limited thereto.

In an embodiment of the present disclosure, the wireless communicator 140 may include at least one wireless communication module, wireless communication circuit or wireless communication device for wirelessly communicating with an external device (e.g., the display device 200). For example, the wireless communicator 140 may include at least one communication module to perform communication according to a communication standard such as Bluetooth, Wi-Fi, Bluetooth low energy (BLE), NFC/RFID, Wi-Fi direct, UWB, Zigbee, Internet, 3G, 4G, 5G and/or 6G. It is not, however, limited thereto, and the configuration and operation of the wireless communicator 140 may be variously implemented according to embodiments of the present present disclosure.

For example, the wireless communicator 140 may include a Wi-Fi module 145. The Wi-Fi module 145 may be a module for performing operations of transmitting or receiving data signals to or from peripheral devices in a Wi-Fi mode according to the Wi-Fi communication standard. The Wi-Fi module 145 may be implemented in a chip. It is not, however, limited thereto.

In an embodiment of the present disclosure, the Wi-Fi module 145 may include the components as shown and described in FIG. 3. The Wi-Fi module 145 may operate in at least one of the MLO mode that both uses the first frequency band and the second frequency band for data transmission, the MIMO mode that uses the first frequency band to transmit data on multiple links, the MIMO mode that uses the second frequency band to transmit data on multiple links, or the MIMO mode that uses the third frequency band to transmit data on multiple links as shown and described in FIGS. 4 to 7. It is not, however, limited thereto.

In an embodiment of the present disclosure, the processor 120 controls general operation of the electronic device 100 and signal flows between internal components of the electronic device 100, and processes data.

The processor 120 may include a single core, dual cores, triple cores, quad cores, and their multiple cores. The processor 120 may include a plurality of processors. For example, the processor 120 may be implemented with a main processor (not shown) and a sub processor (not shown).

The processor 120 may include hardware components for performing arithmetic, logical, and input/output operations and signal processing. The processor 120 may include at least one of e.g., a central processing unit (CPU), a microprocessor, a graphic processing unit (GPU), a video processing unit (VPU), an application specific integrated circuit (ASIC), a digital signal processor (DSP), a digital signal processing device (DSPD), a programmable logic device (PLD), a field programmable gate array (FPGA), an application processor (AP), a neural processing unit (NPU) or an artificial intelligence (AI) specific processor designed in a hardware structure specialized in processing of an AI model, without being limited thereto. Alternatively, the processor 120 may be implemented in the form of a system on chip (SoC) that integrates at least one of the enumerated processors.

In an embodiment of the present disclosure, the memory 130 may include, for example, a non-volatile memory including at least one of a flash memory, a hard disk, a multimedia card micro type memory, a card type memory (e.g., SD or XD memory), a read-only memory (ROM), an electrically erasable programmable ROM (EEPROM), or a programmable ROM (PROM), and a volatile memory such as a random access memory (RAM) or a static RAM (SRAM).

In an embodiment of the present disclosure, the memory 130 may store various data, programs, or applications for driving and controlling the electronic device 100.

The program stored in the memory 130 may include one or more instructions. The program (one or more instructions) or the application stored in the memory 130 may be executed by the processor 120.

In an embodiment of the present disclosure, there may be one or more processors 120. When there are one or more processors 120, operations of the present disclosure may be performed by the one or more processors individually or collectively executing the instructions and/or programs stored in the memory 130.

In a case that the method according to an embodiment includes a plurality of operations, the plurality of operations may be performed by one or more processors 120. For example, when a first operation, a second operation and a third operation are to be performed in a method according to an embodiment of the present disclosure, all the first operation, the second operation and the third operation may be performed by a first processor, or the first operation and the second operation may be performed by the first processor and the third operation may be performed by a second processor.

In an embodiment of the present disclosure, the one or more processors may be implemented as a single core processor or a multi-core processor. In a case that the method according to an embodiment includes a plurality of operations, the plurality of operations may be performed by a single core or performed by multiple cores included in the one or more processors.

In an embodiment of the present disclosure, the processor 120 may individually or collectively execute the one or more instructions stored in the memory 130 to control the wireless communicator 140 to transmit data in the MLO mode that uses the first frequency band and the second frequency band. In an embodiment of the present disclosure, the MLO mode may refer to a technology that simultaneously uses multiple frequency bands for data transmission. For example, the processor 120 may increase the data transmission rate and minimize the latency time by controlling the wireless communicator 140 to transmit data through a first frequency band link and a second frequency band link.

In an embodiment of the present disclosure, the processor 120 may control the wireless communicator 140 to operate in the MLO mode by transmitting data or signal having a frequency band of 5 GHz on a first link and transmitting data or signal having a frequency band of 6 GHz on a second link. In this case, the first link may include a first filter that passes only a frequency band of 5 GHz and the second link may include a second filter that passes only a frequency band of 6 GHz. The method of controlling the wireless communicator 140 to operate in the MLO mode was described in detail with reference to FIG. 4.

In an embodiment of the present disclosure, the processor 120 may individually or collectively execute the one or more instructions stored in the memory 130 to monitor whether interference occurs in the first frequency band or the second frequency band. The occurrence of interference in the first frequency band may refer to degradation of quality of data transmission that uses the first frequency band because many signals using the first frequency band collide with each other. Furthermore, the occurrence of interference in the second frequency band may refer to degradation of quality of data transmission that uses the second frequency band because many signals using the second frequency band collide with each other.

In an embodiment of the present disclosure, the processor 120 may estimate quality of transmission signals of the first frequency band or quality of transmission signals of the second frequency band. For example, the processor 120 may estimate quality of transmission signals based on the number of packets that have failed to be transmitted among a plurality of packets transmitted using the corresponding frequency band, a packet transmission failure rate, the number of packet retransmissions, packet latency time, a time ratio (busy time) of the corresponding frequency band being used for data transmission, etc.

For example, the processor 120 may identify that the higher the number of packets that have failed to be transmitted, the lower the quality of transmission signals and that interference occurs in the corresponding frequency band signal. The processor 120 may identify that the higher the packet transmission failure rate or the higher the number of packet retransmissions, the lower the quality of transmission signals and that interference occurs in the corresponding frequency band signal.

The processor 120 may identify that the longer the packet latency time, the lower the quality of transmission signals and that interference occurs in the corresponding frequency band signal.

The processor 120 may identify that the higher the time ratio of the corresponding frequency band being used for data transmission, the lower the quality of transmission signals and that interference occurs in the corresponding frequency band signal. It is not, however, limited thereto.

In an embodiment of the present disclosure, the processor 120 may individually or collectively execute the one or more instructions stored in the memory 130 to control the wireless communicator 140 to transmit data in the MIMO mode that transmits data on multiple links of the second frequency band when interference occurs in a signal having the first frequency band (S240).

For example, when interference occurs in a signal having a frequency band of 5 GHz, the processor 120 may control the wireless communicator 140 to transmit data having a frequency band of 6 GHz on multiple links. The method of controlling the wireless communicator 140 to operate in the MIMO mode of a frequency band of 6 GHz was described in detail with reference to FIG. 5.

In an embodiment of the present disclosure, the processor 120 may individually or collectively execute the one or more instructions stored in the memory 130 to control the wireless communicator 140 to transmit data in the MIMO mode that transmits data on multiple links of the first frequency band when interference occurs in a signal having the second frequency band.

For example, when interference occurs in a signal having a frequency band of 6 GHz, the processor 120 may control the wireless communicator 140 to transmit data having a frequency band of 5 GHz on multiple links. The method of controlling the wireless communicator 140 to operate in the MIMO mode of a frequency band of 5 GHz was described in detail with reference to FIG. 6.

In an embodiment of the present disclosure, the processor 120 may individually or collectively execute the one or more instructions stored in the memory 130 to control the wireless communicator 140 to operate in the MLO mode by transmitting a signal having a frequency band of 5 GHz on the first link and transmitting a signal having a frequency band of 6 GHz on the second link when no interference occurs in a signal having the first frequency band and a signal having the second frequency band.

In an embodiment of the present disclosure, the processor 120 may individually or collectively execute the one or more instructions stored in the memory 130 to identify characteristics of data to be transmitted. For example, the processor 120 may identify a type of the transmission data, a bandwidth required for the transmission data, real-time properties, confidence, signal quality, etc. It is not, however, limited thereto.

In an embodiment of the present disclosure, the processor 120 may individually or collectively execute the one or more instructions stored in the memory 130 to identify an importance degree of latency of the transmission data based on the characteristics of the transmission data. For example, when the transmission data requires to be transmitted in real-time or requires low latency, the processor 120 may identify that the importance degree of the latency of the transmission data is high. The processor 120 may identify real-time broadcast content such as a sport game, online game content, etc., as data whose latency is highly important. It is not, however, limited thereto.

In an embodiment of the present disclosure, the processor 120 may individually or collectively execute the one or more instructions stored in the memory 130 to control the wireless communicator 140 to transmit data in the MLO mode that uses the first frequency band and the second frequency band when the transmission data is identified as data whose latency is important.

In an embodiment of the present disclosure, the processor 120 may individually or collectively execute the one or more instructions stored in the memory 130 to control the wireless communicator 140 to transmit data in the MIMO mode of the first frequency band or the MIMO mode of the second frequency band when the transmission data is identified as data whose latency is not important.

For example, when interference occurs in the signal having the first frequency band (5 GHz band), the processor 120 may control the wireless communicator 140 to transmit data having the second frequency band (6 GHz band) on multiple links. When interference occurs in the signal having the second frequency band (6 GHz band), the processor 120 may control the wireless communicator 140 to transmit data having the first frequency band (5 GHz band) on multiple links.

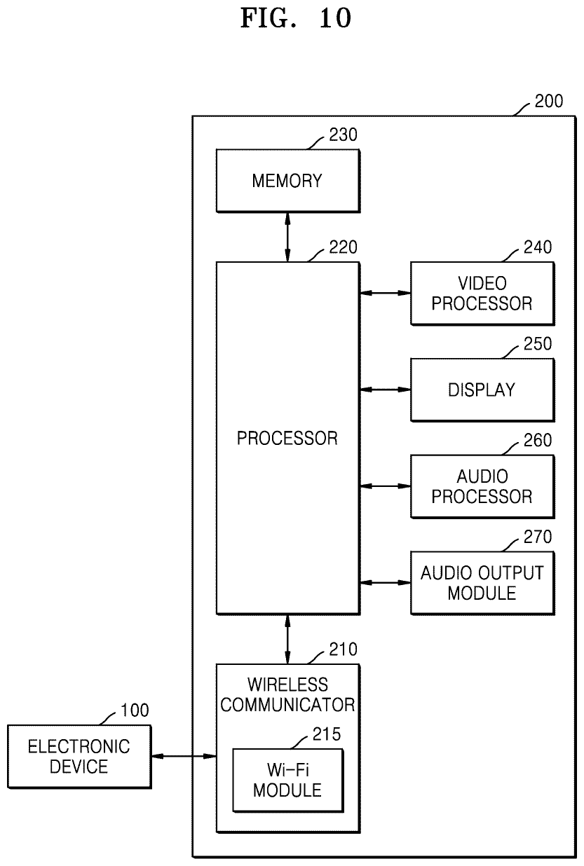

FIG. 10 is a block diagram illustrating a configuration of a display device, according to an embodiment.

Referring to FIG. 10, the display device 200 according to an embodiment may include a wireless communicator 210, a processor 220, memory 230, a video processor 240, a display 250, an audio processor 260 and an audio output module 270.

In an embodiment of the present disclosure, the wireless communicator 210 may include at least one wireless communication module, wireless communication circuit or wireless communication device for wirelessly communicating with an external device (e.g., the electronic device 100). For example, the wireless communicator 210 may include at least one communication module to perform communication according to a communication standard such as Bluetooth, Wi-Fi, Bluetooth low energy (BLE), NFC/RFID, Wi-Fi direct, UWB, Zigbee, Internet, 3G, 4G, 5G and/or 6G. It is not, however, limited thereto, and the configuration and operation of the wireless communicator 210 may be variously implemented according to embodiments of the present present disclosure.

For example, the wireless communicator 210 may include a Wi-Fi module 215. The Wi-Fi module 215 may be a module for performing operations of transmitting or receiving data signals to or from peripheral devices in a Wi-Fi mode according to the Wi-Fi communication standard. The Wi-Fi module 215 may be implemented in a chip. It is not, however, limited thereto.

In an embodiment of the present disclosure, the Wi-Fi module 215 may include the components as shown and described in FIG. 3. Descriptions are focused on the wireless communicator 140 and the Wi-Fi module 145 of the electronic device 100 in FIGS. 3 to 7, and the configurations and operations of the wireless communicator 140 and the Wi-Fi module 215 may be equally applied to the wireless communicator 210 and the Wi-Fi module 215 of the display device 200.

For example, the Wi-Fi module 215 of the display device 200 may include the components as shown and described in FIG. 3, and may operate in at least one of the MLO mode that uses both the first frequency band and the second frequency band for data transmission, the MIMO mode that uses the first frequency band to transmit data on multiple links, the MIMO mode that uses the second frequency band to transmit data on multiple links, or the MIMO mode that uses the third frequency band to transmit data on multiple links as shown and described in FIGS. 4 to 7 for data transmission or reception with an external device (e.g., the electronic device 100). It is not, however, limited thereto.

In an embodiment of the present disclosure, the processor 220 controls general operation of the display device 200 and signal flows between internal components of the display device 200, and processes data.

The processor 220 may include a single core, dual cores, triple cores, quad cores, and their multiple cores. The processor 220 may also include a plurality of processors. For example, the processor 220 may be implemented with a main processor (not shown) and a sub processor (not shown).

The processor 220 may include hardware components for performing arithmetic, logical, and input/output operations and signal processing. The processor 220 may include at least one of e.g., a central processing unit (CPU), a microprocessor, a graphic processing unit (GPU), a video processing unit (VPU), an application specific integrated circuit (ASIC), a digital signal processor (DSP), a digital signal processing device (DSPD), a programmable logic device (PLD), a field programmable gate array (FPGA), an application processor (AP), a neural processing unit (NPU) or an artificial intelligence (AI) specific processor designed in a hardware structure specialized in processing of an AI model, without being limited thereto. Alternatively, the processor 220 may be implemented in the form of a system on chip (SoC) that integrates at least one of the enumerated processors.

In an embodiment of the present disclosure, the memory 230 may include, for example, a non-volatile memory including at least one of a flash memory, a hard disk, a multimedia card micro type memory, a card type memory (e.g., SD or XD memory), a read-only memory (ROM), an electrically erasable programmable ROM (EEPROM), or a programmable ROM (PROM), and a volatile memory such as a random access memory (RAM) or a static RAM (SRAM).

In an embodiment of the present disclosure, the memory 230 may store various data, programs, or applications for driving and controlling the display device 200.

The program stored in the memory 230 may include one or more instructions. The program (one or more instructions) or the application stored in the memory 230 may be executed by the processor 220.

In an embodiment of the present disclosure, there may be one or more processors 220. When there are one or more processors 220, operations of the present present disclosure may be performed by the one or more processors individually or collectively executing the instructions and/or programs stored in the memory 130.

In an embodiment of the present disclosure, the processor 220 may perform the operations performed by the processor 120 of the electronic device 100 as described in connection with FIG. 9.

For example, the processor 220 may individually or collectively execute the one or more instructions stored in the memory 230 to control the wireless communicator 210 to transmit data in the MLO mode that uses the first frequency band and the second frequency band.

The processor 220 may individually or collectively execute the one or more instructions stored in the memory 230 to monitor whether interference occurs in the first frequency band or the second frequency band.

The processor 220 may individually or collectively execute the one or more instructions stored in the memory 230 to control the wireless communicator 210 to transmit data in the MIMO mode that transmits data on multiple links of the second frequency band when interference occurs in a signal having the first frequency band.

The processor 220 may individually or collectively execute the one or more instructions stored in the memory 230 to control the wireless communicator 210 to transmit data in the MIMO mode that transmits data on multiple links of the first frequency band when interference occurs in a signal having the second frequency band.

The processor 220 may individually or collectively execute the one or more instructions stored in the memory 230 to control the wireless communicator 210 to operate in the MLO mode or the MIMO mode based on characteristics (e.g., latency characteristics) of data to be transmitted.

In an embodiment of the present disclosure, the video processor 240 may process video data received by the display device 200. The video processor 240 may perform various image processes such as decoding, scaling, noise removal, frame rate conversion, resolution conversion, image quality processing, etc., on the video data.

In an embodiment of the present disclosure, the display 250 generates a driving signal by converting an image signal, a data signal, an on-screen display (OSD) signal, a control signal, etc., processed by the processor 120. The display 250 may be implemented by a PDP, an LCD, OLEDs, a flexible display, or a three dimensional (3D) display, or the like. Furthermore, the display 250 may have a touchscreen to be used for an input device as well as for an output device.

In an embodiment of the present disclosure, the display 250 may output image data corresponding to an image content received from the electronic device 100.

The audio processor 260 processes audio data. The audio processor 260 may perform various processes such as decoding, amplification, noise removal, etc., on the audio data. The audio processor 260 may include a plurality of audio processing modules to process audio corresponding to a plurality of contents.

The audio output module 270 may output audio, e.g., voice or sound, received by the display device 200. Furthermore, the audio output module 270 may output audio stored in the memory 230 under the control of the processor 220. The audio output module 270 may include at least one of a speaker, a headphone output terminal or a Sony/Phillips digital interface (S/PDIF) output terminal.

The block diagrams of the electronic device 100 shown in FIG. 9 and the display device 200 shown in FIG. 10 are merely for an embodiment. Components of the block diagrams may be merged, added or omitted according to actual specifications of the electronic device 100 and the display device 200. In other words, two or more components may be merged into one, or a single component may be split into two or more components as needed. Functions performed in the blocks are shown for explaining the embodiment of the present disclosure, and the present disclosure is not limited to the detailed operation or components corresponding to the blocks.

According to an embodiment of the present disclosure, an electronic device may include a wireless communicator for transmitting or receiving data to or from an external device, memory storing one or more instructions, and at least one processor including processing circuitry.

In an embodiment of the present disclosure, the one or more instructions, when executed by the at least one processor individually or collectively, may cause the electronic device to control the wireless communicator to operate in a multi-link operation (MLO) mode that simultaneously uses a first frequency band and a second frequency band adjacent to the first frequency band to transmit data.

In an embodiment of the present disclosure, the one or more instructions, when executed by the at least one processor individually or collectively, may cause the electronic device to control the wireless communicator to operate in a multi-input multi-output (MIMO) mode that uses one of the first frequency band and the second frequency band for data transmission based on an occurrence of interference in the first frequency band or the second frequency band.

In an embodiment of the present disclosure, the wireless communicator may include a Wi-Fi module.

In an embodiment of the present disclosure, the first frequency band may include a 5 GHz band, and the second frequency band may include a 6 GHz band.

In an embodiment of the present disclosure, the one or more instructions, when executed by the at least one processor individually or collectively, may cause the electronic device to monitor whether interference occurs in the first frequency band or the second frequency band based on the quality of a network over which signals of the first frequency band or signals of the second frequency band are transmitted.

In an embodiment of the present disclosure, the quality of the network may be determined based on at least one of the number of transmission failures of a data packet transmitted over the network, a transmission failure rate of the data packet, the number of retransmissions of the data packet, latency time of the data packet, or a time ratio (busy time) of the corresponding frequency band being used for data transmission.

In an embodiment of the present disclosure, the wireless communicator may include a first filter that passes a signal of only the second frequency band, a second filter that passes a signal of only the first frequency band, a first switch that switches a signal having the first frequency band or a signal having the second frequency band output through the first port to the first filter or the first diplexer, and a second switch that switches a signal having the first frequency band or a signal having the second frequency band output through the second port to the second filter or the second diplexer.

In an embodiment of the present disclosure, a signal output from the first filter or the first diplexer may be transmitted to the external device through a first antenna.

In an embodiment of the present disclosure, a signal output from the second filter or the second diplexer may be transmitted to the external device through a second antenna.

In an embodiment of the present disclosure, the one or more instructions, when executed by the at least one processor individually or collectively, may cause the electronic device to control the wireless communicator to operate in the MLO mode by controlling the first switch so that a signal output through the first port is input to the first filter and controlling the second switch so that a signal output through the second port is input to the second filter.

In an embodiment of the present disclosure, the one or more instructions, when executed by the at least one processor individually or collectively, may cause the electronic device to control the wireless communicator to operate in the MIMO mode that uses the second frequency band for data transmission by controlling the first switch so that a signal output through the first port is input to the first filter and controlling the second switch so that a signal output through the second port is input to the second diplexer based on interference occurring in the first frequency band.

In an embodiment of the present disclosure, the one or more instructions, when executed by the at least one processor individually or collectively, may cause the electronic device to control the wireless communicator to operate in the MIMO mode that uses the first frequency band for data transmission by controlling the first switch so that a signal output from the first port is input to the first diplexer and controlling the second switch so that a signal output from the second port is input to the second filter based on interference occurring in the second frequency band.

In an embodiment of the present disclosure, the one or more instructions, when executed by the at least one processor individually or collectively, may cause the electronic device to determine whether to operate the wireless communicator in the MLO mode or the MIMO mode based on latency characteristics of transmission data.

In an embodiment of the present disclosure, the one or more instructions, when executed by the at least one processor individually or collectively, may cause the electronic device to control the wireless communicator to operate in a MIMO mode that uses a third frequency band for data transmission.

According to an embodiment of the present disclosure, an operating method of an electronic device may include operating in a multi-link operation (MLO) mode that simultaneously uses a first frequency band and a second frequency band adjacent to the first frequency band for data transmission.

In an embodiment of the present disclosure, the operating method of the electronic device may include monitoring whether interference occurs in the first frequency band or the second frequency band.

In an embodiment of the present disclosure, the operating method of the electronic device may include operating in a multi-input multi-output (MIMO) mode that uses the second frequency band for data transmission, based on interference occurring in the first frequency band.

In an embodiment of the present disclosure, the operating method of the electronic device may include operating in an MIMO mode that uses the first frequency band for data transmission based on interference occurring in the second frequency band.

In an embodiment of the present disclosure, the first frequency band may include a 5 GHz band, and the second frequency band may include a 6 GHz band.

In an embodiment of the present disclosure, the monitoring of whether interference occurs in the first frequency band or the second frequency band may include monitoring whether interference occurs in the first frequency band or the second frequency band based on the quality of a network over which signals of the first frequency band or signals of the second frequency band are transmitted.

In an embodiment of the present disclosure, the monitoring of whether interference occurs in the first frequency band or the second frequency band may include determining the quality of the network based on at least one of the number of transmission failures of a data packet transmitted over the network, a transmission failure rate of the data packet, the number of retransmissions of the data packet, latency time of the data packet, or a time ratio of the corresponding frequency band being used for data transmission (busy time).

In an embodiment of the present disclosure, the wireless communicator of the electronic device may include a first filter that passes a signal of only the second frequency band, a second filter that passes a signal of only the first frequency band, a first switch that switches a signal having the first frequency band or a signal having the second frequency band output through the first port to the first filter or the first diplexer, and a second switch that switches a signal having the first frequency band or a signal having the second frequency band output through the second port to the second filter or the second diplexer.

In an embodiment of the present disclosure, the operating in the MLO mode that simultaneously uses the first frequency band and the second frequency band adjacent to the first frequency band for data transmission may include operating in the MLO mode by controlling the first switch so that a signal output through the first port is input to the first filter and controlling the second switch so that a signal output through the second port is input to the second filter.

In an embodiment of the present disclosure, the operating in the MIMO mode that uses the second frequency band for data transmission based on the occurrence of interference in the first frequency band may include operating in the MIMO mode that uses the second frequency band for data transmission by controlling the first switch so that a signal output through the first port is input to the first filter and controlling the second switch so that a signal output through the second port is input to the second diplexer.

In an embodiment of the present disclosure, the operating in the MIMO mode that uses the first frequency band for data transmission based on the occurrence of interference in the second frequency band may include operating in the MIMO mode that uses the first frequency band for data transmission by controlling the first switch so that a signal output from the first port is input to the first diplexer and controlling the second switch so that a signal output from the second port is input to the second filter.

In an embodiment of the present disclosure, the operating method of the electronic device may further include determining whether to operate a wireless communicator of the electronic device in the MLO mode or the MIMO mode based on latency characteristics of the transmission data.

In an embodiment of the present disclosure, the operating method of the electronic device may further include operating in the MIMO mode that uses a third frequency band for data transmission.

In an embodiment of the present disclosure, the electronic device may operate in an MLO mode that simultaneously uses a first frequency band (5 GHz band) and a second frequency band (6 GHz band) adjacent to the first frequency band for data transmission without interference between the first frequency band and the second frequency band.

In an embodiment of the present disclosure, the electronic device may operate in a MIMO mode that uses the first frequency band or the second frequency band for data transmission on multiple links to avoid interference when the interference occurs in the first frequency band or the second frequency band.

In an embodiment of the present disclosure, the electronic device may operate in a MIMO mode that uses a third frequency band (2.4 GHz band) along with the first frequency band or the second frequency band for data transmission on multiple links.

Accordingly, the electronic device according to an embodiment may increase the data transmission rate and minimize the latency time. The electronic device may also maintain stability of data communication connection and increase transmission efficiency.

In an embodiment of the present disclosure, the electronic device may efficiently transmit data by determining a data transmission mode according to characteristics of transmission data.

In an embodiment of the present disclosure, the operating method of the electronic device may be implemented in program instructions which may be executable by various computing means and recorded on a computer-readable medium The computer-readable medium may include program instructions, data files, data structures, etc., separately or in combination. The program instructions recorded on the medium may be designed and configured specially for the present disclosure, or may be well-known to those of ordinary skill in the art of computer software. Examples of the computer readable recording medium include a magnetic medium such as a hard disk, a floppy disk and a magnetic tape, an optical medium such as a compact disc read-only memory (CD-ROM) and a digital versatile disc (DVD), a magneto-optical medium such as a floptical disk, and a hardware device specially configured to store and perform program instructions, such as a read-only memory (ROM), a random-access memory (RAM), a flash memory, etc. Examples of the program instructions include not only machine language codes but also high-level language codes which are executable by various computing means using an interpreter.

Furthermore, the operating method of the electronic device according to the embodiments of the present disclosure may be included and provided in a computer program product. The computer program product may be a commercial product that may be traded between a seller and a buyer.

The computer program product may include a software program and a computer-readable storage medium having the software program stored thereon. For example, the computer program product may include a product in the form of a software program that is electronically distributed by the manufacturer of the electronic device or by an electronic market (e.g., Google play store®, or App store®). For the electronic distribution, at least a portion of the software program may be stored in a storage medium or arbitrarily created. In this case, the storage medium may be one of a server of the manufacturer or of a relay server that temporarily stores the software program.

In a system including a server and a client device, the computer program product may include a storage medium of the server or a storage medium of the client device. Alternatively, when there is a third device (e.g., a smart phone) communicatively connected to the server or the client device, the computer program product may include a storage medium of the third device. In another example, the computer program product may be transferred from the server to the client device or the third device, or may include a software program itself that is transferred from the third device to the client device.

In this case, one of the server, the client device, and the third device may execute the computer program product to perform the method according to the embodiments of the present disclosure. Alternatively, two or more of the server, the client device, and the third device may execute the computer program product to perform the method according to the embodiments of the present disclosure in a distributed fashion.

For example, the server (e.g., a cloud server or an AI server) may execute the computer program product stored therein to control the client device communicatively connected to the server to perform the method according to the embodiments of the present disclosure.

Several embodiments of the present disclosure have been described, but it will be understood that various modifications can be made without departing the scope of the present disclosure. Thus, it will be apparent to those ordinary skill in the art that the present disclosure is not limited to the embodiments described, but can encompass not only the appended claims but the equivalents.

What is claimed is:

1. An electronic device comprising:
a wireless communicator configured to communicate data with an external device;
memory storing one or more instructions; and
at least one processor including processing circuitry,
wherein the one or more instructions, when executed by the at least one processor individually or collectively, cause the electronic device to:
control the wireless communicator to operate in a multi-link operation (MLO) mode that is configured to simultaneously use a first frequency band and a second frequency band adjacent to the first frequency band for data transmission; and
control the wireless communicator to operate in a multi-input multi-output (MIMO) mode that is configured to use the first frequency band or the second frequency band for data transmission based on an occurrence of interference in the first frequency band or the second frequency band.

2. The electronic device of claim 1, wherein the wireless communicator comprises a Wi-Fi module,
wherein the first frequency band comprises a 5 GHz band, and
wherein the second frequency band comprises a 6 GHz band.

3. The electronic device of claim 1, wherein the one or more instructions, when executed by the at least one processor individually or collectively, further cause the electronic device to monitor whether interference occurs in the first frequency band or the second frequency band based on quality of a network over which a signal of the first frequency band or a signal of the second frequency band is transmitted.

4. The electronic device of claim 3, wherein the quality of the network is determined based on at least one of a number of transmission failures of a data packet transmitted over the network, a transmission failure rate of the data packet, a number of retransmissions of the data packet, latency time of the data packet, or a time ratio of a corresponding frequency band being used for data transmission.

5. The electronic device of claim 1, wherein the wireless communicator comprises:
a first filter configured to pass a signal of only the second frequency band;
a second filter configured to pass a signal of only the first frequency band;
a first switch configured to switch the signal of the first frequency band or the signal of the second frequency band from a first port to the first filter or a first diplexer; and
a second switch configured to switch the signal of the first frequency band or the signal of the second frequency band from a second port to the second filter or a second diplexer,
wherein a signal output from the first filter or the first diplexer is transmitted to the external device through a first antenna, and
wherein a signal output from the second filter or the second diplexer is transmitted to the external device through a second antenna.

6. The electronic device of claim 5, wherein the one or more instructions, when executed by the at least one processor individually or collectively, further cause the electronic device to control the wireless communicator to operate in the MLO mode based on control of the first switch so that a signal output from the first port is input to the first filter, and the second switch so that a signal output from the second port is input to the second filter.

7. The electronic device of claim 5, wherein the one or more instructions, when executed by the at least one processor individually or collectively, cause the electronic device to, based on an occurrence of interference in the first frequency band, control the wireless communicator to operate in the MIMO mode configured to use the second frequency band for data communication based on control of the first switch so that a signal output from the first port is input to the first filter, and the second switch so that a signal output from the second port is input to the second diplexer.

8. The electronic device of claim 5, wherein the one or more instructions, when executed by the at least one processor individually or collectively, cause the electronic device to, based on an occurrence of interference in the second frequency band, control the wireless communicator to operate in the MIMO mode which uses the first frequency band for data transmission based on control of the first switch so that a signal output from the first port is input to the first diplexer, and the second switch so that a signal output from the second port is input to the second filter.

9. The electronic device of claim 1, wherein the one or more instructions, when executed by the at least one processor individually or collectively, cause the electronic device to determine whether to operate the wireless communicator in the MLO mode or the MIMO mode based on latency characteristics of transmission data.

10. The electronic device of claim 1, wherein the one or more instructions, when executed by the at least one processor individually or collectively, further cause the electronic device to control the wireless communicator to operate in the MIMO mode configured to use a third frequency band for data transmission.

11. A method of operating an electronic device, the method comprising:
operating in a multi-link operation (MLO) mode to simultaneously use a first frequency band and a second frequency band adjacent to the first frequency band for data transmission;
monitoring whether interference occurs in the first frequency band or the second frequency band;
operating in a multi-input multi-output (MIMO) mode to use the second frequency band for data transmission based on an occurrence of interference in the first frequency band; and
operating in a MIMO mode to use the first frequency band for data transmission based on an occurrence of interference in the second frequency band.

12. The method of claim 11, wherein the first frequency band includes a 5 GHz band, and
wherein the second frequency band includes a 6 GHz band.

13. The method of claim 11, wherein the monitoring of whether interference occurs in the first frequency band or the second frequency band is based on quality of a network over which a signal of the first frequency band or a signal of the second frequency band is transmitted.

14. The method of claim 13, wherein the monitoring of whether interference occurs in the first frequency band or the second frequency band comprises determining the quality of the network based on at least one of a number of transmission failures of a data packet transmitted over the network, a transmission failure rate of the data packet, a number of retransmissions of the data packet, latency time of the data packet, or a time ratio of a corresponding frequency band being used for data transmission.

15. The method of claim 11, wherein a wireless communicator of the electronic device includes:
a first filter configured to pass a signal of only the second frequency band;
a second filter configured to pass a signal of only the first frequency band;
a first switch configured to switch the signal of the first frequency band or the signal of the second frequency band from a first port to the first filter or a first diplexer; and
a second switch configured to switch the signal of the first frequency band or the signal of the second frequency band from a second port to the second filter or a second diplexer,
wherein the operating in the MLO mode to simultaneously use the first frequency band and the second frequency band adjacent to the first frequency band for data transmission comprises:
controlling the first switch so that a signal output through the first port is input to the first filter; and
controlling the second switch so that a signal output through the second port is input to the second filter.

16. The method of claim 15, wherein the operating in the MIMO mode to use the second frequency band for data transmission based on the occurrence of interference in the first frequency band comprises:
controlling the first switch so that a signal output from the first port is input to the first filter; and
controlling the second switch so that a signal output from the second port is input to the second diplexer.

17. The method of claim 15, wherein the operating in the MIMO mode to use the first frequency band for data transmission based on the occurrence of interference in the second frequency band comprises:
controlling the first switch so that a signal output from the first port is input to the first diplexer; and
controlling the second switch so that a signal output from the second port is input to the second filter.

18. The method of claim 11, further comprising:
determining whether to operate a wireless communicator of the electronic device in the MLO mode or the MIMO mode based on latency characteristics of transmission data.

19. The method of claim 11, further comprising:
operating in a MIMO mode to uses a third frequency band for data transmission.

20. A non-transitory computer-readable medium having stored therein a program for performing the method of claim 11.
